(19) United States
(12) Patent Application Publication
(10) Pub. No.: US 2007/0242142 A1
(43) Pub. Date: Oct. 18, 2007

(54) Image restoration apparatus, camera and program

(75) Inventor: Mitsuhiro Okazaki, Saitama-shi (JP)

Correspondence Address: OLIFF & BERRIDGE, PLC, P.O. BOX 19928, ALEXANDRIA, VA, 22320, US

(73) Assignee: NIKON CORPORATION, TOKYO (JP)

(21) Appl. No.: 11/783,726

(22) Filed: Apr. 11, 2007

(30) Foreign Application Priority Data
Apr. 14, 2006 (JP) 2006-112240
Apr. 9, 2007 (JP) 2007-101323

(51) Int. Cl. H04N 5/228

(52) U.S. Cl. 348/239; 348/222.1

(57) ABSTRACT

The present invention provides an image restoration apparatus, a camera and a program which are capable of performing image restoration with simple construction. A specific area within a captured image is specified, and a calculation of a point spread function and the image restoration calculation are carried out using an image in the specific area.

This disclosure of the following priority application is herein incorporated by references: Japanese Patent Applications No. 2006-112240 filed on 14 Apr. 2006, and No. 2007-101323 filed on 9th Apr., 2007.

### BACKGROUND OF THE INVENTION

1. Field of the Invention

The present invention relates to an image restoration apparatus, a camera and a program.

2. Description of Related Art

An optical image vibration reducing apparatus that reduces image vibration caused by hand movement at the time of shooting a photograph is known. Another vibration reducing apparatus is known as well, which is capable of reducing image vibration by an image restoration (for example, refer to Japanese Unexamined Patent Publication Application No. 2004-205799).

### SUMMARY OF THE INVENTION

An object of the present invention is to provide an image restoration apparatus, a camera, and a program, which are capable of restoring an image with a simple construction.

According to the present invention, the above-mentioned object is achieved by the following solutions.

A first aspect of the present invention is an image restoration apparatus comprising: a specific part that specifies a specific area within a captured image; and a calculating part that calculates a point spread function using an image in the specific area within the captured image, and performs an image restoration calculation for the captured image using the point spread function.

In the first aspect of the invention, it may be the image restoration apparatus in which the calculating part calculates the point spread function through iterative computation.

In the first aspect of the invention, it may be the image restoration apparatus in which the specific part specifies an area within the captured image in which a main subject exists, as the specific area.

A second aspect of the present invention is a camera including the image restoration apparatus.

In the second aspect of the invention, it may be the camera in which the specific part sets an area corresponding to a focal point detecting area set within a capture field of view of the camera as the specific area.

In the second aspect of the invention, it may be the camera in which the specific part specifies the specific area again in response to a change in the composition of the captured image.

In the second aspect of the invention, it may be the camera in which the specific part specifies the area of the captured image in which the subject specified prior to the change in the composition exists, when the composition of the captured image is changed, and sets the specified area as the specific area.

In the second aspect of the invention, it may be the camera in which the specific part compares the specific area specified prior to the change in composition and the captured image after the change in composition to specify the specific area again when the composition of the captured image is changed.

In the second aspect of the invention, it may be the camera in which an image in the specific area specified prior to the change in composition is the image when imaging conditions of a lens are fixed, and also the image in an area corresponding to the focal point detecting area set within the capture field of view of the camera.

In the second aspect of the invention, it may be the camera in which the specific part specifies a subject located in the focal point detecting area set within a capture field of view when imaging conditions of the lens are fixed, specifies the area of the subject within a capture field of view by tracking the subject, and sets the specified area as the specific area.

In the second aspect of the invention, it may be the camera in which the specific part sets an area including a face of a subject as the specific area.

In the second aspect of the invention, it may be the camera in which the specific part sets an area including an eye of the face as the specific area.

In the second aspect of the invention, it may be the camera includes an input part that inputs a position within the captured image, and the specific part sets an area within the captured image corresponding to the position inputted by the input part as the specific area.

In the second aspect of the invention, it may be the camera including a control part that controls the calculating part, and the calculating part carries out the image restoration calculation when a control signal is supplied from the control part.

In the second aspect of the invention, it may be the camera in which the control part supplies the control signal to the calculating part when it is determined that the captured image includes image vibration.

A third aspect of the present invention is a camera comprising: a specific part that specifies a specific area within a captured image; and an output part that outputs the captured image and information about the specific area specified by the specific part.

A fourth aspect of the present invention is an image restoration apparatus comprising: an input part to which a captured image and information about a specific area within the captured image are inputted; and a calculating part that calculates a point spread function using an image in the specific area within the captured image, and carries out the image restoration calculation for the captured image using the point spread function.

In the fourth aspect of the invention, it may be the image restoration apparatus in which the calculating part calculates the point spread function through iterative computation.

A fifth aspect of the present invention is a program that makes a computer function as: a specific part that specifies a specific area within a captured image; and a calculating part that calculates a point spread function using an image in the specific area within the captured image, and performs an image restoration calculation for the captured image using the point spread function.

In the fifth aspect of the invention, it may be the program in which the calculating part calculates the point spread function through iterative computation.

A sixth aspect of the present invention is a camera comprising: a specific part that specifies a specific area corresponding to a focal point detecting area set within a capture field of view; and a correction part that corrects image vibration included in a captured image using the specific area.

A seventh aspect of the present invention is a camera comprising: a specific part that specifies a specific area including a face of a subject within a captured image; and a correction part that corrects image vibration included in a captured image using the specific area.

An eighth aspect of the present invention is a camera comprising: a specific part that specifies a specific area corresponding to a focal point detecting area set within a capture field of view; and an output part that outputs information about the specific area specified by the specific part along with a captured image.

A ninth aspect of the present invention is an image restoration apparatus comprising: an input part to which a captured image and information about a specific area corresponding to a focal point detecting area set within a capture field of view; and a correction part that corrects image vibration included in the captured image using the specific area.

A tenth aspect of the present invention is a camera comprising: a specific part that specifies a specific area including a face of a subject within a captured image; and an output part that outputs information about the specific area specified by the specific part along with a captured image.

An eleventh aspect of the present invention is an image restoration apparatus comprising: an input part to which a captured image and information about a specific area including a face of a subject within the captured image are inputted; and a correction part that corrects image vibration included in the captured image using the specific area.

In the fifth aspect of the invention, it may be the program in which the specific part specifies the specific area based on a feature of a subject.

In the fifth aspect of the invention, it may be the program making a computer function as a subject feature input part that inputs the feature of the subject.

In the fifth aspect of the invention, it may be the program in which the specific part uses at least a face of the subject as the feature of the subject.

In the fifth aspect of the invention, it may be the program making a computer function as a specific area selecting part that selects one specific area when there are a plurality of specific areas specified based on the feature of the subject by the specific part.

In the fifth aspect of the invention, it may be the program in which the specific area selecting part selects an area having the highest degree of definition of an image as a specific area.

In the fifth aspect of the invention, it may be the program in which the specific area selecting part selects an area having the largest area of a captured image as a specific area.

In the first aspect of the invention, it may be the image restoration apparatus in which the specific part specifies the specific area based on a feature of a subject.

In the first aspect of the invention, it may be the image restoration apparatus which comprises a subject feature input part that inputs a feature of the subject.

In the first aspect of the invention, it may be the image restoration apparatus in which the specific part uses at least a face of a subject as the feature of the subject.

In the first aspect of the invention, it may be the image restoration apparatus which comprises a specific area selecting part that selects at least one of a plurality of the specific areas specified based on the feature of the subject by the specific part.

In the first aspect of the invention, it may be the image restoration apparatus in which the specific area selecting part selects a specific area having the highest degree of definition of an image.

In the first aspect of the invention, it may be the image restoration apparatus in which the specific area selecting part selects a specific area including the largest subject.

In the second aspect of the invention, it may be the camera in which the specific part specifies the specific area based on a feature of a subject.

In the second aspect of the invention, it may be the camera which comprises a subject feature input part that inputs the feature of the subject.

In the second aspect of the invention, it may be the camera in which the specific part uses at least a face of a subject as the feature of the subject.

In the second aspect of the invention, it may be the camera which comprises a specific area selecting part that selects one specific area when there are a plurality of specific areas specified based on the feature of the subject by the specific part.

In the second aspect of the invention, it may be the camera in which the specific area selecting part selects an area having the highest degree of definition of an image as a specific area.

In the second aspect of the invention, it may be the camera in which the specific area selecting part selects an area having the largest area the captured image as a specific area.

In the second aspect of the invention, it may be the camera in which the calculating part interrupts or aborts the image restoration calculation when a higher priority command is made active during the execution of the image restoration calculation.

In the second aspect of the invention, it may be the camera in which the higher priority command includes any operation selected from the group of operations consisting of: operation of a release button, operation of a menu button, operation of a command selecting dial, and operation of a power supply button.

In the second aspect of the invention, it may be the camera in which the calculating part resumes the restoration calculation after completion of operations based on the higher priority command.

In the second aspect of the invention, it may be the camera which comprises an optical vibration reducing part that reduces image vibration of a captured image by moving at least part of an optical shooting member during shooting action, the calculating part is capable of performing the image restoration calculation for the captured image obtained by use of the optical vibration reducing part.

It is should be noted that the configurations mentioned above may be improved as appropriate. In addition, any other component may be substituted for at least a part of them, and constituent requirements without any special limitation of its arrangement is not limited to arrangement disclosed in embodiments.

According to the present invention, since a point spread function is calculated using an image in a specific area within a captured image, it is possible to perform image restoration with simple construction.

### BRIEF DESCRIPTION OF THE DRAWINGS

FIG. 1 is a figure showing a general outline of a camera according to a first embodiment;

FIG. 2 is a flowchart showing a flow of an operation in the case of an S-mode being selected in the camera of the present embodiment;

FIG. 3 is a figure for explaining an operation of an AF area information acquiring part in the case of an S-mode being selected;

FIG. 4 is a figure schematically representing PSF in a two-dimensional domain;

FIG. 5 is a figure showing a distribution of AF areas of the camera of the first embodiment;

FIG. 6 is a figure showing a general outline of a camera according to a second embodiment;

FIG. 7 is a figure showing an example of selection of an AF area of the camera of the second embodiment;

FIG. 8 is a figure showing a general outline of a camera system according to a third embodiment;

FIG. 9 is a figure showing a camera according to a fourth embodiment;

FIG. 10 is a figure showing a general outline of a camera of the fourth embodiment;

FIG. 11 is a figure showing a general outline of an image restoration apparatus according to a fifth embodiment; and

FIG. 12 is a flowchart for explaining an operation of the image restoration apparatus of the fifth embodiment.

### DETAILED DESCRIPTION OF THE INVENTION

Hereinafter, more detailed description of the invention will be given by way of embodiments with reference to the drawings and more.

### First Embodiment

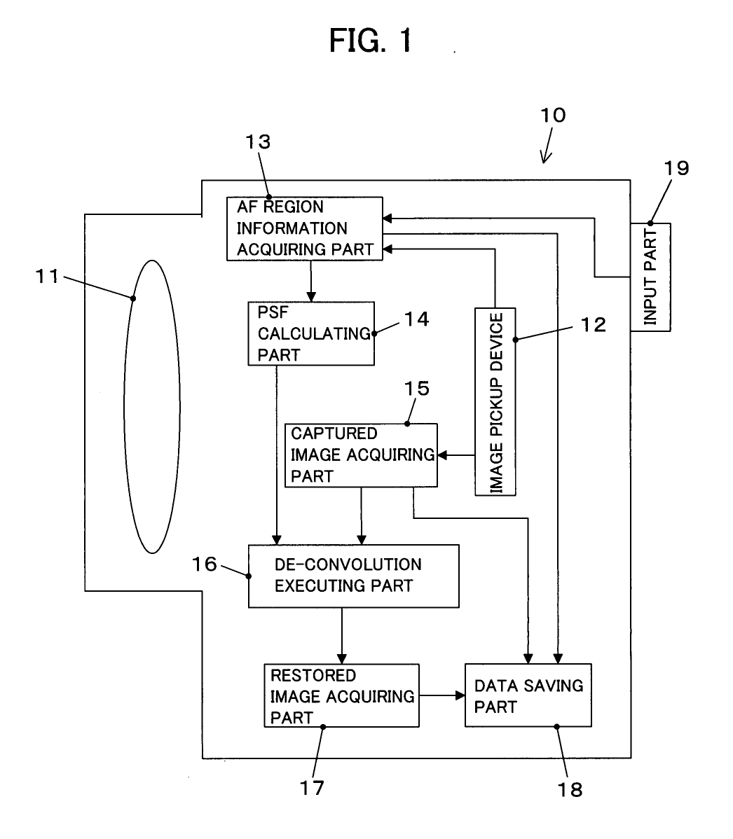

FIG. 1 is a figure showing an outline of a camera according to a first embodiment.

A camera 10 of the first embodiment comprises a lens 11, an image pickup device 12, an AF area information acquiring part 13, a PSF calculating part 14, a captured image acquiring part 15, a de-convolution executing part 16, a restored image acquiring part 17, a data saving part 18, an input part 19, and so on.

The lens 11 is a lens for leading light from a photographic subject to the image pickup device 12 and forming an image on the device 12.

The image pickup device 12 is a device for picking up an image formed on a capturing surface by the lens 11, and in this embodiment, CCD (Charge Coupled Device) is used for the pickup device 12. It is noted that such an image pickup device is not limited to the CCD, other types of image sensors such as CMOS (Complementary Metal Oxide Semiconductor) device may be employed for the image pickup device.

The AF area information acquiring part 13 acquires information about an AF (Auto Focus) area used for focusing in an auto focus (AF) operation, and specifies a position of a main subject within a captured image.

The PSF calculating part 14 calculates a PSF (Point Spread Function) from the captured image. A PSF is used in calculation of de-convolution described later.

It is noted that the AF area information acquiring part 13 and PSF calculating part 14 are parts of a control part (calculating processing part) that generally controls an operation of a camera.

The captured image acquiring part 15 is a part for temporarily storing a captured image that the pickup device 12 has picked up.

The de-convolution executing part 16 is a part for executing an image restoration calculation for the captured image data by use of a PSF calculated by the PSF calculating part 14, and in this embodiment, performs de-convolution so as to reduce image vibration included in the captured image.

The restored image acquiring part 17 is a part for temporarily storing a restored image obtained as a result of executing de-convolution in the de-convolution executing part 16.

The data saving part 18 is a part for saving a captured image and a restored image, and for this embodiment, is intended to record them on a removable memory card.

The input part 19 is a manipulating member capable of various kinds of input operations.

Now an AF operation performed by a camera of the present embodiment is described.

The camera of the embodiment can select an S-mode or C-mode as the AF operation.

The S-mode is an AF mode of focus-priority type, in which picture shooting is only allowed when an in-focus indicator, not shown, is turned on by pressing a shutter button halfway. In the S-mode, if the in-focus indicator is turned on under the condition of the halfway pressing of the shutter button, AF locking is then allowed for the duration of the halfway pressing of the shutter button, thereby to keep the focusing condition without any adjustment of focusing. Thus, as far as the shutter button is pressed halfway, a condition (in-focus state) on which a focal point is adjusted on the subject having been subjected to the AF locking could be kept even if the subject departed from the AF area for change of photograph composition.

The C-mode is an AF mode of release-priority type, in which a shooting act can be taken regardless of the in-focus indication at any time whenever the shutter button is pressed the whole way, and in which focusing adjustment is continued at all times during the halfway pressing of the shutter button. Consequently, when changing the composition, it continues to drive the lens 11 to focus onto a subject in any position covered by the AF area.

An operation of a camera according to this embodiment will now be described. It should be noted that operations described below assumes that settings are made to perform image restoration, but in the case of settings not to perform image restoration, it is also possible to perform much the same operations as the conventionally-known cameras with no operations associated with the image restoration.

Firstly, description is given about operations in the case of the S-mode being selected as an AF mode. In the following description, discussion will be offered on the assumption that a person is chosen as a main subject and the person is to be in focus. A main subject is not limited to a person, and may be any other article. For the sake of simplification, also noted is that description will be given on the assumption that an AF area 21 is only singly provided at a center of a shooting range.

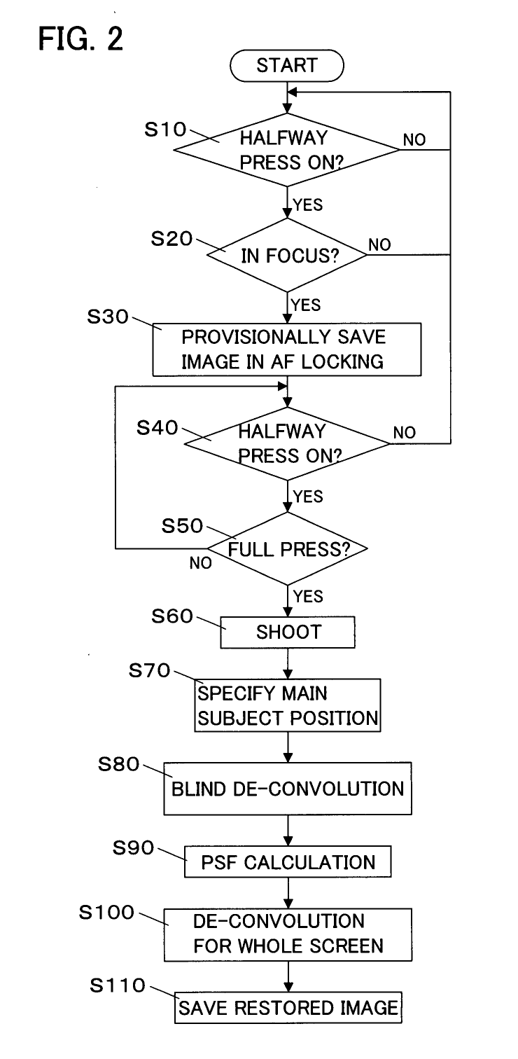

FIG. 2 is a flowchart showing flows of operations in the case of the S-mode being selected in a camera according to this embodiment.

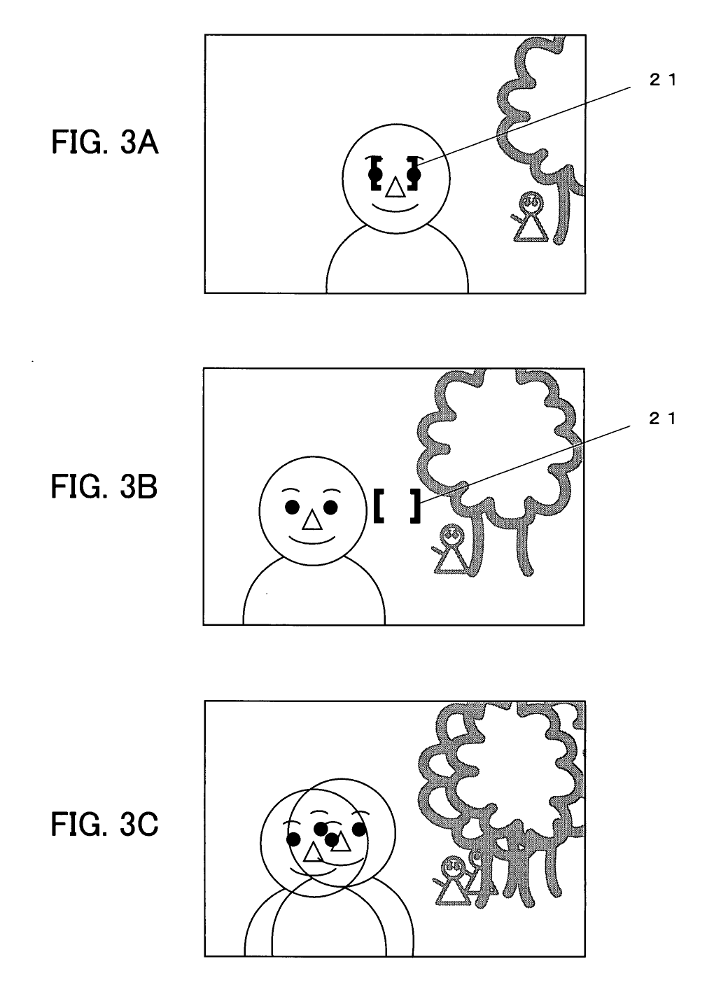

FIG. 3 is an illustration for describing operations of the AF area information acquiring part in the case of the S-mode being selected.

In a step (hereinafter, expressed just as “S”) 10, it is determined whether or not the shutter button is pressed halfway. If the shutter button is pressed halfway, then the flow proceeds to S20, but if the shutter button is not pressed halfway, then the judgment of S10 is repeated.

In S20, it is determined whether or not focus is achieved. If in focus, the flow proceeds to S30, but if out of focus, the flow returns to S10.

In the S-mode, the shutter button is pressed halfway under a situation where the AF area 21 covers the person so as to achieve focus (FIG. 3A). When focus has been achieved, the in-focus indicator (not shown) lights up and the camera is in an AF-locked state in which the focusing conditions are held.

In S30, the AF area information acquiring part 13 provisionally saves an image at the time of AF locking, which is obtained by the image pickup device 12 when the AF locking is performed, while storing a position of the AF area 21 that has been used at the time of AF locking.

In S40, it is determined whether or not the halfway pressing of the shutter button is continued. In the case where the shutter button continues to be pressed halfway, the flow proceeds to S50, and in the case where the shutter button is not pressed halfway, the flow returns to S10.

When change of a picture composition is desired, the composition is changed with the shutter button remaining pressed halfway on the condition that the in-focus indicator lights up (FIG. 3B). In the example shown in FIG. 3, the change in composition is realized in such a manner that a person is positioned to the left and a background tree is positioned on the right side of a capture field of view, but conditions that the person is in focus is maintained since the halfway pressing of the shutter button is continued.

In S50, it is determined whether the shutter button is pressed in the whole way or not. If the shutter button is pressed in the whole way, the flow proceeds to S60, and if the shutter button is not pressed in the whole way, the flow returns to S40.

In S60, image shooting is realized in the pickup device 12, a captured image is obtained (FIG. 3C). FIG. 3C also shows an example that image vibration occurs because of instability of hand movement at the moment of shooting action.

In S70, the AF area information acquiring part 13 compares the captured image and the image at the time of AF locking, that has been provisionally saved at that time, so as to specify at which position within the captured image the subject covered by the AF area 21 at the time of AF locking is located. It is noted that this comparison of the subjects may be implemented in a way that a plurality of feature points are extracted from the image obtained at the time of AF locking and search for the feature points is made in the captured image, for example.

If a position of the subject having been covered by the AF area 21 at the time of AF locking is specified in the captured image, then the AF area information acquiring part 13 informs the PSF calculating part 14 of information of the specified position.

In S80, the blind de-convolution is started.

Now, image restoration is described.

There is a method, referred to as “image restoration”, that is schemed to bring an image deteriorated due to image vibration or something else close to a less deteriorated, ideal image.

Provided that (x, y) is a position coordinate on the screen, an image obtained at the time of no vibration nor something like that (hereinafter, referred to as “original image”) is f(x, y), an image deteriorated due to vibration or something like that (hereinafter, referred to as “deteriorated image”) is g(x, y), a point spread function (PSF) that is information about point images spread by camera vibration or something like that is h(x, y), and noise is n(x, y), the following relationship is held among them.

g(x, y)=f(x, y)\textcircled{x}h(x, y)+n(x, y)

\textcircled{x} denote de-convolution

If the point spread function h(x, y) and the noise n(x, y) are known, then the original image f(x, y) is obtained from the deteriorated image g(x, y) by carrying out de-convolution that is inverse operation of convolution.

Besides, even if the point spread function h(x, y) and the noise n(x, y) are unknown, there is a technique of achieving image restoration from the deteriorated image g(x, y) to the original image f(x, y), a method of image restoration, referred to as “blind de-convolution”, is described by G. R. Ayers and J. C. Dainty, “Iterative blind de-convolution method and its applications, “Optics Letters, vol. 13(7), pp. 547-549, July 1988. In the present embodiment, this blind de-convolution is used to obtain a restored image with less image vibration from a captured image including some image vibration.

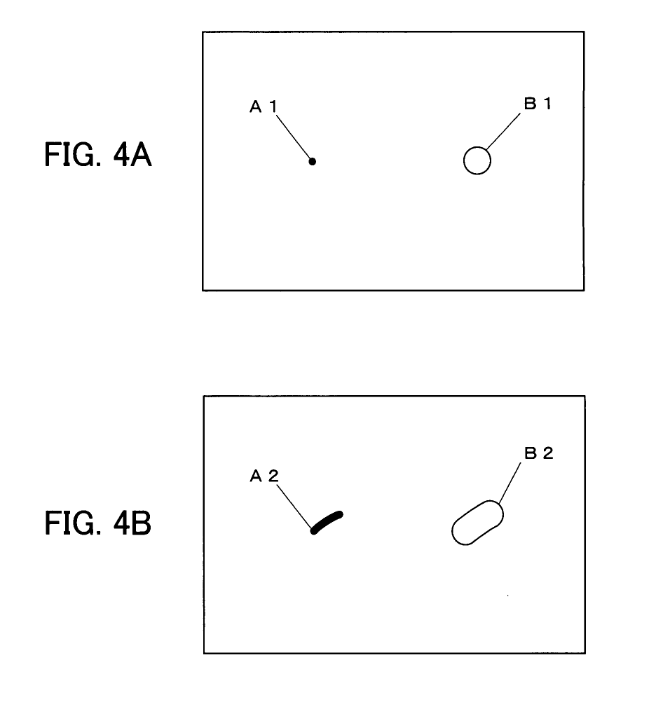

FIG. 4 is a figure schematically representing PSFs on a two-dimensional domain. FIG. 4A shows the case of no image vibration, and FIG. 4B shows the case where image vibration is added to the PSFs of FIG. 4A. The PSFs of FIG. 4 are depicted correspondingly to FIG. 3.

The PSFs of FIG. 4A belong to the case where the state shown in FIG. 3B is shot ideally without any image vibration. In the state of FIG. 3B, the person is in focus whereas the background tree is out of focus. Accordingly, when discussing the PSFs corresponding to them, as shown in FIG. 4A, the PSF in a position corresponding to the person becomes a point as shown in A1, and the PSF in a position of the background tree becomes a range B1 spread by effect of defocusing.

The PSFs of FIG. 4B belong to the case of a captured image including image vibration as in FIG. 3C. These PSFs of FIG. 4B further include components corresponding to loci of the image vibration in addition to the PSFs of FIG. 4A in response to effect of the image vibration.

When the blind de-convolution is applied to the captured image of FIG. 3C and the PSFs are obtained so as to obtain a restored image, a quality of the obtained restored image widely varies depending on at what position within the captured image is used to obtain a PSF.

On the condition that the blind de-convolution is performed using a partial image of the background tree portion of FIG. 3C, the resultant PSF is that shown in B2 of FIG. 4B. FIG. 4B is shown schematically, so that it shows as if locus components of the image vibration is accurately obtained in the PSF, but in practice, the partial image of the tree portion is out of focus, thereby resulting in a PSF in which the image vibration and the defocusing are combined, whereby the locus components of the image vibration is not accurately reflected onto the PSF. Moreover, if a restored image is obtained from the PSF of this B2, not only image vibration components but also defocus components are included in the PSF, so that not only computation for reducing the image vibration of the partial image of the background tree portion but also computation for reducing the defocus of the partial image of the background tree portion can be performed. If image restoration could be ideally carried out for this background tree portion, it would result in a partial image of the tree with being in focus but without any image vibration. In practice, however, it no longer results in an image the photographer has intended. Then, the computation is performed on the whole of a capture field of view, so that the defocus is enhanced even though the image vibration of a partial image of the person portion may be reduced. Therefore, it is not preferable to carry out the blind de-convolution by use of the partial image of the background tree portion.

On the other hand, if the blind de-convolution is performed using the partial image of the person portion of FIG. 3C, the resultant PSF will be that shown by A2 in FIG. 4B. Since the person portion is in focus, the locus components of the image vibration is accurately reflected onto the PSF, with no defocus component being included in this PSF. Therefore, if a restored image is obtained from the PSF of this A2, only the image vibration components are reduced and the partial image of the person portion is satisfactorily obtained with no image vibration and with being in focus. Furthermore, for the background tree portion, a satisfactory image can be obtained with no image vibration and with having defocus that was intended by the photographer at the time of shooting.

Thus, it is important what position of an image to be used within the captured image should be taken to carry out the blind de-convolution, in respect of improving a quality of the resultant restored image.

Returning to FIG. 2, for the reason as described above, this embodiment is intended to specify at what position the subject covered by the AF area 21 at the time of AF locking is located within the captured image and transmit the position information to the PSF calculating part 14 in S70.

In S90, the PSF calculating part 14 carries out the PSF calculation using the captured image. The calculation of the PSF refers the information transmitted in S70, i.e., the information about what position the subject covered by the AF area 21 at the time of AF locking is located at within the captured image, and performs the calculation of the PSF using an image at the corresponding position. In this way, an ideal PSF can be obtained as mentioned above. It is noted that the subject covered by the AF area 21 at the time of AF locking is usually a main subject the photographer wants to shoot more clearly, and from this point of view, execution of the calculation of the PSF for this position of the subject leads to good results.

In S100, de-convolution is performed for the whole area of the captured image using the resultant PSF so as to obtain a restored image.

In S110, the obtained restored image is saved. In addition to the restored image, the captured image can also be saved together.

The foregoing description is directed to the case of the S-mode being selected as an AF mode, but the following description will be given for the case of the C-mode being selected as an AF mode.

In the case of the C-mode being selected as an AF mode, the focusing on the subject covered by the AF area 21 until is operated just before the shutter button is pressed all the way. Therefore, in such a C-mode selection case, it is appropriate to assume that a main subject within the captured image is located at a position covered by the AF area 21 at the time of shooting. The AF area information acquiring part 13 in the C-mode being selected is predicated on a condition that the main subject exists in a position covered by the AF area 21 at the time of shooting, and sends the corresponding information to the PSF calculating part 14.

The foregoing description has been given on the assumption that the AF area 21 is provided in a single center of the captured image capture field of view for the sake of simplification, but a camera according to this embodiment may have plural AF areas 21 arranged in a plurality of positions within the captured image capture field of view as well as in the center of the capture field of view.

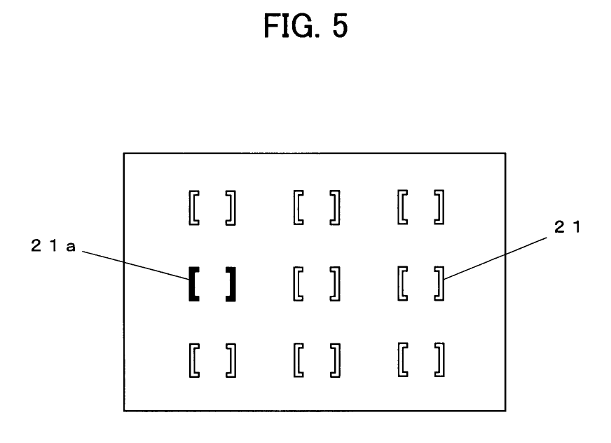

FIG. 5 is a figure showing an arrangement of the AF areas in a camera of the first embodiment.

In the example shown in FIG. 5, the AF areas 21 are arranged at nine points. The camera of this embodiment performs its AF operation using one of the AF areas 21 at these nine points, the one being decided by choice of the photographer or an automatic choice of the camera. In this connection, when the photographer selects an AF area 21 to be used, such selecting is realized by manipulating the input part 19. The AF area 21 selected by manipulating the input part 19 is made different in display from the other AF areas in order to distinguish it from the others. In this embodiment, a displayed color is modified like the AF area 21a shown in FIG. 5.

Although the foregoing description has been given on the assumption that the AF area information acquiring part 13 specifies a position of the main subject automatically, the position of the main subject specified by the AF area information acquiring part 13 may be displayed prior to execution of the blind de-convolution, and that position may be modified with the input part 19 being manipulated by the photographer.

Furthermore, a position to be used for the PSF calculation may be designated by manipulating the input part 19 without any operation of the AF area information acquiring part 13.

The modification or designation of a position to be used for the PSF calculation using the input part 19 may be implemented by extra setting using a selecting menu or something else.

Thus, since the input part 19 can be used to designate or modify a position to be used for the PSF calculation, an intention of the photographer can be accurately reflected thereon, thereby to increase a probability that satisfactory restored image can be obtained.

According to this embodiment, since a position of a main subject is specified using the information about the AF area 21 used in the AF operation and the PSF is calculated for the specified position, image restoration can be performed with taking account of an intention of the shooting so that a favorable restored image can be obtained.

In addition, it is possible to designate and modify a position to be used for the PSF calculation using the input part 19, so that a position of the main subject can be specified more reliably.

### Second Embodiment

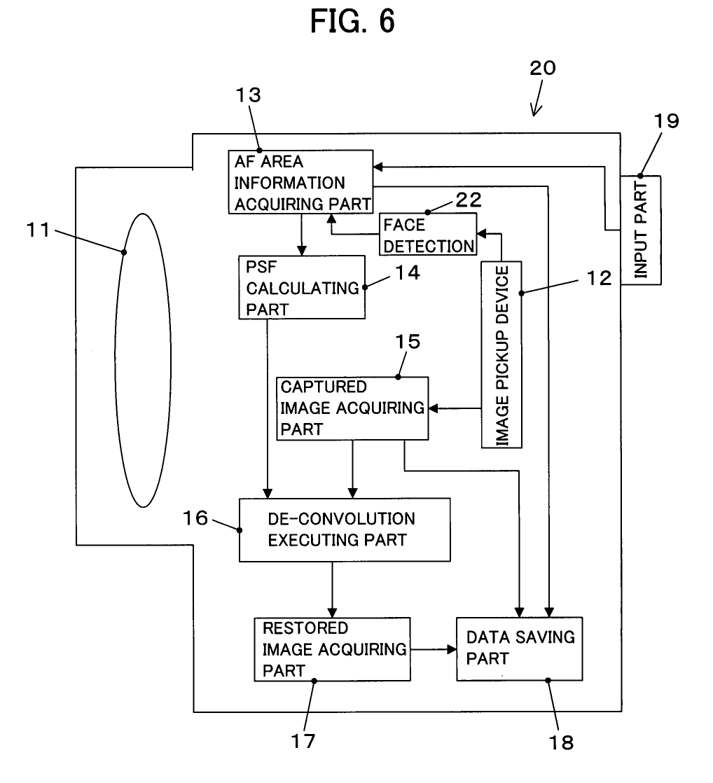

FIG. 6 is a figure showing a general configuration of a camera according to the second embodiment.

Herein, components having much the same functions as those in the foregoing first embodiment are denoted by the same reference symbols, upon which overlapping description will be omitted as appropriate.

A camera 20 of the second embodiment is equivalent to a form in which a face position detecting part 22 is further added to the camera 10 of the first embodiment.

The face position detecting part 22 acquires various kinds of information such as information about a contour shape of a face, distances or intervals of the respective parts including eyes, a nose, a mouth, ears, etc., and a color of skin, from image data before shooting, the data being held in the image pickup device 12, and recognizes a human face as a result of calculation and analyzing operation using the information so as to detect a position of the face.

The camera 20 of this embodiment is intended to bring an AF area to a position of the face detected by the face position detecting part 22, and focuses on that position. By doing so, shooting with the face being in focus is enabled regardless of any positions of the person's face within an image screen. Furthermore, even if a distance or position with respect to the subject is changed because of e.g. movement of the person or composition changing, the face position detecting part 22 continues to detect a position of the face.

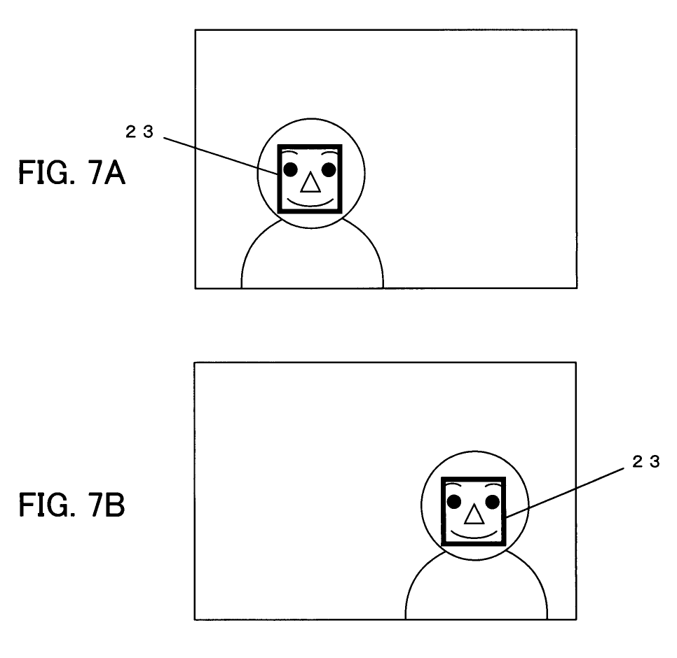

FIG. 7 shows an example of selection of an AF area of the camera of the second embodiment. As shown in FIG. 7A and (b) in this figure, the AF area 23 is placed in a position of the person's face even though the composition is changed.

Since the face position detecting part 22 also specifies a position of his/her eye when detecting the face, position information of the eye is sent to the AF area information acquiring part 13.

The AF area information acquiring part 13 sends the position information of the eye, obtained from the face position detecting part 22, to the PSF calculating part 14, and the PSF calculating part 14 obtains a PSF for an image in the position of the eye.

It is desirable to focus on an eye in the field of photographs targeting persons. In addition, an eye is a photographic subject that can be considered as substantially a point, and allows the PSF calculation to be accurately performed.

According to this embodiment, therefore, it is possible to carry out the PSF calculation more accurately and obtain a more favorable restored image in the field of photography targeted for persons.

### Third Embodiment

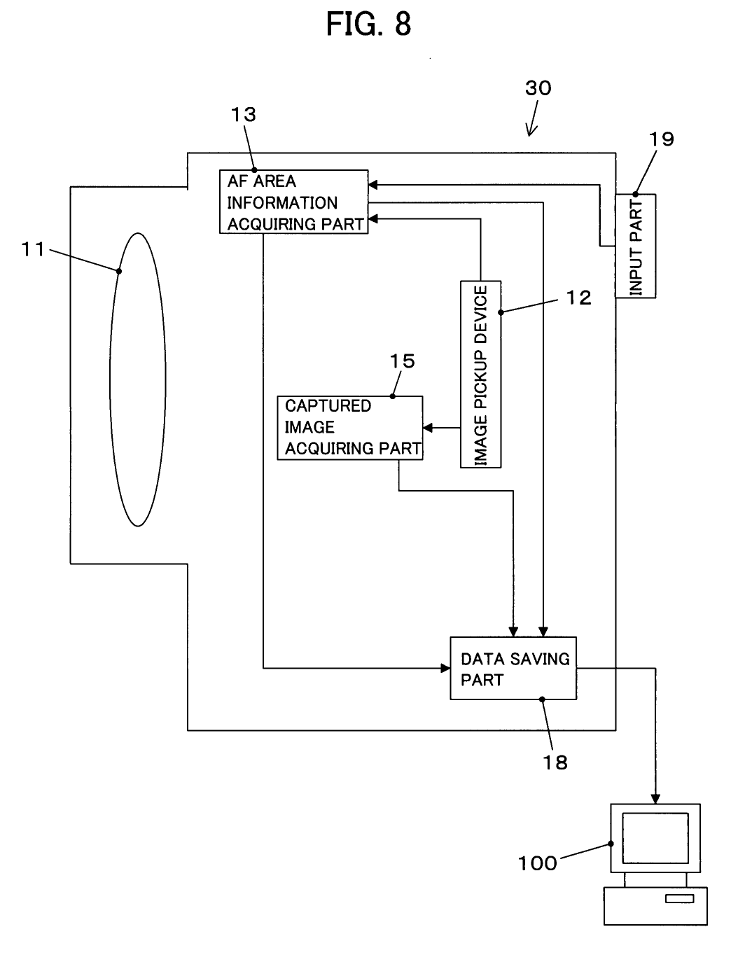

FIG. 8 is a figure representing a general configuration of a camera system according to the third embodiment.

Herein, components having much the same functions as those in the foregoing first embodiment are denoted by the same reference symbols, upon which overlapping description will be omitted as appropriate.

The camera system of the third embodiment comprises a camera 30 and a program installed in the computer 100.

The camera 30 of the third embodiment does not equip the PSF calculating part 14, de-convolution executing part 16 and restored image acquiring part 17 provided in the camera 10 of the first embodiment.

The AF area information acquiring part 13 provided in the camera 30 of the third embodiment specifies a position of a main subject within a captured image in a manner similar to the first embodiment. Information about the position of a main subject is added to the data of the captured image, which has been held in the captured image acquiring part 15, and the resultant data are saved in the data saving part 18.

The program installed in the computer 100 of the third embodiment includes a program causing the computer 100 to operate as follows upon installation of the program to the computer 100.

The program included in the camera system of the third embodiment causes the captured image data additionally having information about a position of a main subject, which has been saved in the data saving part 18, to be inputted to the computer 100. It should be noted that the way to input data saved in the data saving part 18 to the computer 100 may involve intervention of a memory card, measures capable of wired or wireless communication between the camera 30 and the computer 100 or intervention of different kinds of networks. Besides, the data saved in the data saving part 18 can be replicated, and therefore may be inputted to the computer 100 via a storage medium other than a memory card, e.g. a recording disk medium or the like.

The program included in the camera system of the third embodiment causes the computer 100 to operate in much the same manner as the PSF calculating part 14, de-convolution executing part 16 and restored image acquiring part 17 in the first embodiment.

The computer 100 in which the above-mentioned program is installed refers the position information of a main subject, which is obtained in concurrence with the inputted captured image data, and for the captured image data, calculates a PSF in blind de-convolution from an image of the corresponding position to obtain a restored image.

As an image restoration such as de-convolution requires an enormous amount of operations, the computer 100 may be utilized so as to carry out such operations at a high speed. The computer 100 may also utilized so as to conduct condition setting for image restoration calculation or something like that more precisely.

### Fourth Embodiment

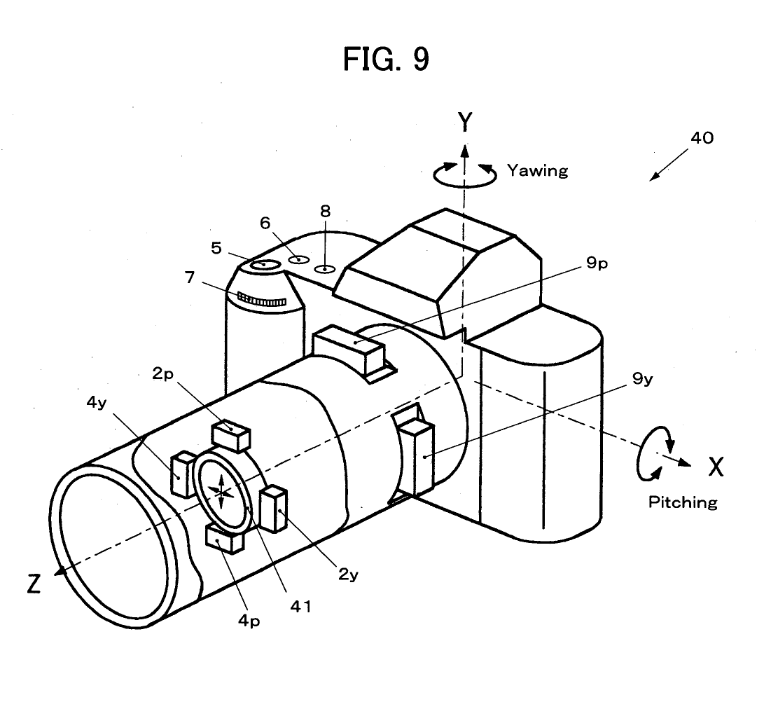

FIG. 9 is an illustration showing a camera according to the fourth embodiment.

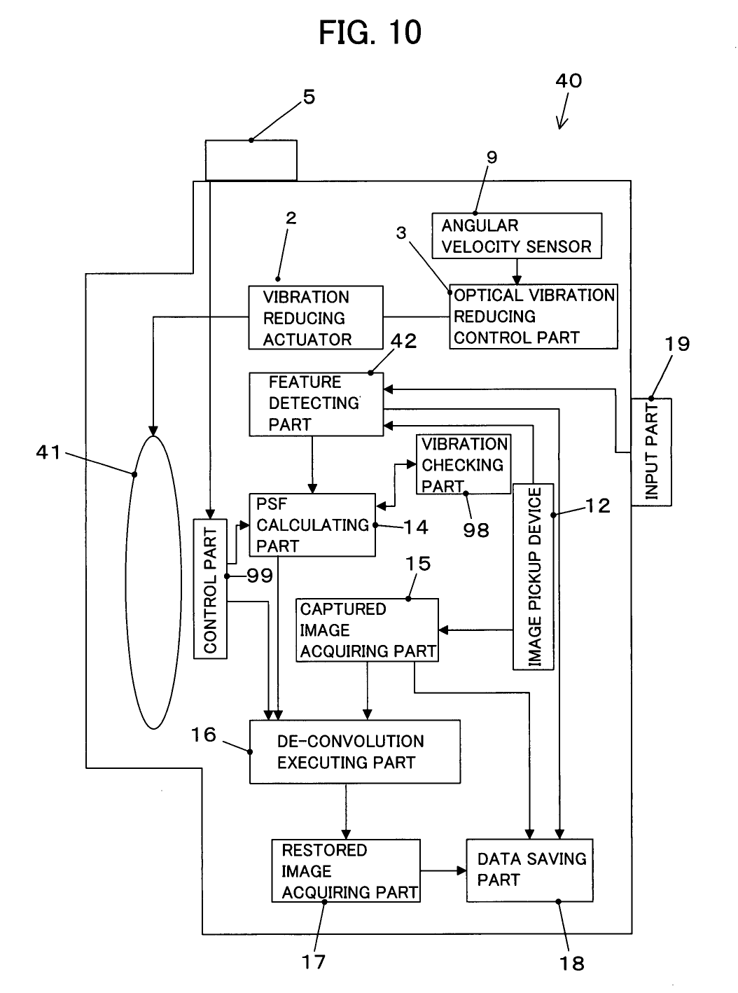

FIG. 10 is a figure representing a general configuration of the camera of the fourth embodiment.

The camera 40 of the fourth embodiment is intended to add an optical camera vibration reducing part and a feature detecting part 42 to the camera 10 of the first embodiment. In the present embodiment, it is possible to perform image restoration even for an image captured using the optical vibration reducing part by virtue of equipping the optical vibration reducing part. Firstly, such an optical vibration reducing part is described.

Herein, components having much the same functions as those in the foregoing first embodiment are denoted by the same reference symbols, upon which overlapping description will be omitted as appropriate.

The camera 40 has a lens 41, a camera vibration reducing actuator 2 (2p, 2y), an optical vibration reduction control part 3, a lens position detecting sensor 4 (4p, 4y), a release switch 5, a menu switch 6, a command selecting dial 7, a power supply switch 8, a vibration sensor 9 (9p, 9y), a feature detecting part 42, and so on.

The lens 41 forms a part of a photo-shooting optical system, and is provided movably with respect to the image pickup device 12 (mentioned later) in a plane substantially perpendicular to an optical axis Z. The lens 41 is comparable to a vibration reduction optical system for reducing vibration of image in the image pickup device 12 in such a way that the lens counter-moves in a direction in which the image vibration in an image of a subject due to vibration of the camera 40 is canceled.

The camera vibration reducing actuator 2 is a driving part comparable to generate driving force to move the lens 41, for which a voice coil motor or something else is used, for example. The vibration reducing actuator 2 comprises a vibration reducing actuator 2p driven at the time of correction for image vibration in a Pitching direction and a vibration reducing actuator 2y driven at the time of correction for image vibration in a Yawing direction.

The optical vibration reduction control part 3 is a circuit for driving the vibration reducing actuator 2, and performs driving for the vibration reducing actuator 2 in accordance with a driving target computed by a vibration reduction computing circuit, not shown.

The lens position detecting sensor 4 is a position sensor for detecting a position of the lens 41, and comprises a lens position detecting sensor 4p for detecting a position of the lens 41 at the time of correction for image vibration in a Pitching direction and a lens position detecting sensor 4y for detecting a position of the lens 41 at the time of correction for image vibration in a Yawing direction.

The vibration sensor 9 is an angular velocity sensor for detecting an angular velocity of the camera 40, and comprises a vibration sensor 9p for detecting Pitching vibration and a vibration sensor 9y for detecting Yawing vibration.

The camera 40 in this embodiment equips the two-system-type vibration reducing actuator 2, lens position detecting sensor 4, vibration sensor 9 and other control system for Pitching and Yawing, which drive the lens 41 so as to optically correct image vibration caused in the Pitching and Yawing.

The release switch 5 is a 2-step switch manipulated at the time of starting a shooting operation, and if its first step of stage is turned ON (pressed halfway), a shooting preparation operation such as photometric measurement and AF operation is started, and if its second step of stage is turned ON (pressed fully), a shutter (not shown) is activated and the shooting is started.

A menu switch 6 is a button for conducting display of a menu relating to various kinds of operations and selection of them.

A command selecting dial 7 is a rotating switch for changing a choice or numerical value sequentially by undergoing rolling manipulation, e.g. at the time of selecting a choice on the occasion of inputting for various kinds of operations.

A power supply switch 8 is a switch for switching between ON and OFF of a power supply for the camera.

This embodiment can perform image restoration even for an image shot using the above-described optical vibration reducing part. In this way, it is possible to correct image vibration that can not be completely corrected only by the optical vibration reduction. On the other hand, the optical vibration reduction has a higher possibility that a more satisfactory image is obtained than the image restoration in the case of image vibration due to hand movement, but has a characteristic in that image vibration caused by subject movement can not optimally be processed for correction. According to this embodiment, by combining the optical vibration reduction and the image restoration, it is possible to perform image burring correction that makes full use of their respective characteristics depending on the situation.

Next there will be description of the feature detecting part 42 added to the camera 10 of the first embodiment in accordance with the present embodiment.

The feature detecting part 42 is a part for detecting an area fitting to a feature of a subject designated by the photographer from image data captured by the image pickup device 12. As features of subjects used for detection in the feature detecting part 42, there are, for example, a face of a human, a face of an animal, a building, an automobile, a train, an airplane, a boat/ship, a flower, etc. In the case of detecting a face of a human, the face is detected in operations similar to the second embodiment. As for other features, their respective features are also detected in an image processing. The feature detecting part 42 detects, from an image, a subject fitting to a feature of a subject (e.g., a face of a human, a face of an animal) selected by the photographer's operation of the input part 19 prior to shooting among features of subjects registered beforehand in the feature detecting part 42, and identifies a position of the detected subject from within the captured image.

The PSF calculating part 14, according to information of the position of the subject (main subject) detected by the feature detecting part 42, carries out the PSF calculation using an image at the specified position of the main subject. By so doing, it is possible to obtain an ideal PSF.

In this embodiment, although information about an area fitting to a feature of the subject detected by the feature detecting part 42 is used for the calculation of PSF, this position information area may also be used to determine an AF area as with the second embodiment.

Herein, the feature detecting part 42 can detect more than one area in which there is a subject fitting to the selected subject feature. For example, when a selected feature of a subject is a face of a human, there may be plural persons within a subject field to be shot. In this case, the feature detecting part 42 specifies a main subject for plurally selected areas in accordance with the preset conditions, and the PSF calculating part 14 carries out the PSF calculation using an image at a position of the specified subject. When plural areas fitting to a feature of a subject have been detected by the feature detecting part 42, the PSF calculating part 14 carries out the following operations selectively.

### (Mode 1)

The plurality of areas detected are displayed on a display part, not shown, and the PSF calculation is carried out for an area selected and inputted by the photographer via the input part 19, and subsequently de-convolution is performed using the obtained PSF.

### (Mode 2)

The PSF calculation is carried out for the plurality of areas detected, respectively, and the calculation results are averaged to further obtain an average PSF. De-convolution is performed using this average PSF.

### (Mode 3)

One area is automatically selected from the plurality of areas detected, and the PSF calculation is carried out for the selected area, and then de-convolution is performed by the obtained PSF. As a way to automatically select one area, it is possible to choice either of the following two ways: one way to select an area in which a sharp image with the highest degree of definition is obtained; and another way to select an area having the greatest ratio of an area occupied within the captured image”.

As for which of the above-mentioned three Modes should be used and for which way should be used for the automatic selection in the case of Mode 3, the input part 19 may be used to let the photographer select and input it beforehand or select and input it every time occasion demands.

In this embodiment, a main subject can be specified more exactly using a feature of a subject as described above, and therefore, it is possible to acquire a satisfactory image meeting an intention of the photographer

The process of the PSF calculation and de-convolution described above requires complicated calculate processing and tends to take long processing time. During such processing, if other operation can not done, then the photographer has to wait for a completion of the processing, and further it is thought to lose a photo opportunity. With this being the situation, the present embodiment is intended to interrupt an image restoration calculation when any command with a higher priority are made active during execution of such an image restoration calculation as PSF calculation and de-convolution processing. In this embodiment, operation of the release switch 5, operation of the menu switch 6, operation of a command selecting dial 7, and operation of the power supply switch 8 are set as higher priority command. If the above-mentioned higher priority command is made active, the control part 99 causes the parts 14 and 16 to interrupt the image restoration calculation is interrupted and the operation is changed to an operation according to the corresponding higher priority command for operation of the release switch 5, operation of the menu switch 6, operation of a command selecting dial 7, and operation of the power supply switch 8.

(1) If the release switch 5 is manipulated during an image restoration calculation, the control part 99 stops supplying of a control signal causing the parts 14 and 16 to execute the image restoration calculation so as to interrupt the image restoration calculate operation of the parts 14 and 16 and to change over to the shooting operation. By doing so, the shooting can be prioritized. After completing the shooting operation, a process in progress of the interrupted image restoration calculation is read out to resume the image restoration calculation.
(2) If the menu switch 6 or the command dial 7 is manipulated during an image restoration calculation, the control 99 stops supplying of a control signal to the parts 14 and 16 to interrupt the image restoration calculation, and various kinds of setting operations according to the operation of the menu switch 6 or the operation of the command selecting dial 7 is accepted. After the command is completed or a predetermined time (e.g., 10 seconds) elapses from after no manipulating occurs, the image restoration calculation is resumed. Because various kinds of setting operations based on the operation of the menu switch 6 or the operation of the command selecting dial 7 are burdened with lower processing load than the above-mentioned shooting operation, the process in progress of the image restoration calculation does not have to be saved in a memory (not shown) within the camera body or the data saving part 18. However, if some command to execute a processing having a heavy processing load, such as browsing and processing of the already-captured images, processing according to the operation of the menu switch 6 or the operation of the command selecting dial 7 is executed after the process in progress of the image restoration calculation.
(3) If the power supply switch 8 is manipulated, or more specifically, if the power supply is turned OFF during execution of the image restoration calculation, the image restoration calculation is interrupted and trunk-retracting operation for a lens barrel or the like takes place, so as to become a power-down state in appearance. Subsequently, the image restoration calculation is resumed, and when the restored image is obtained, it is saved and thereafter the power supply for the processing circuit is turned OFF. In this case, display for teaching that the image restoration is being executed as back processing may be performed at the time of power-OFF.

Thus, in the present embodiment, the PSF calculation and de-convolution processing does not interfere with any commands when the photographer wants to make other commands during the image restoration calculation, whereby a camera with great manipulability can be achieved.

Referring to FIG. 10, a vibration checking part 98 checks whether or not the captured image includes image vibration, for example, based on the calculation results of the PSF calculating part 14.

For example, the control part 99 provides a control signal causing the parts 14 and 16 to execute the image restoration calculation to the parts 14 and 16 when the vibration checking part 98 has checked that image vibration is included, and it does not provide the control signal to the parts 14 and 16 when it has checked that the image vibration is not included.

### Fifth Embodiment

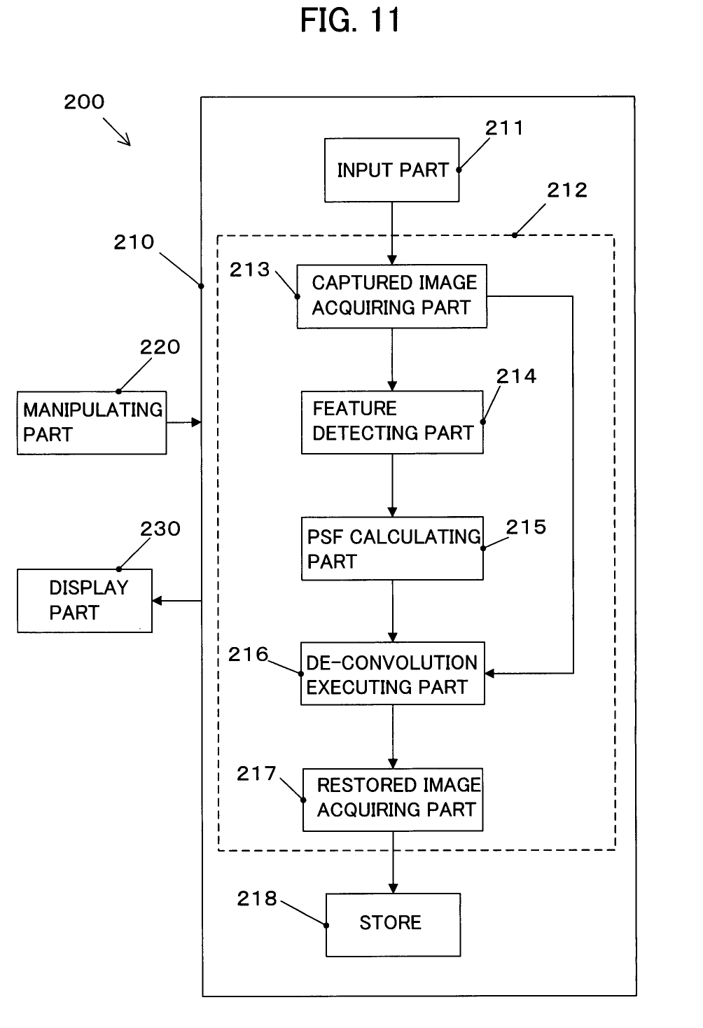

FIG. 11 is a figure showing a general configuration of an image restoration apparatus according to the fifth embodiment.

An image restoration apparatus 200 comprises a computer 210, a manipulating part 220 and a display part 230.

The computer 210 is a computer having an input part 211, a calculate processing part 212, a storing part 218, and more. Herein, it is assumed that a computer is not limited to general-purpose devices such as personal computers, and may include any devices comprising a dedicated calculate processing part that is specialized for image restoration processing.

The input part 211 is a device for inputting various kinds of information from the external, and may be a device for reading data from a medium such as a memory card or data recoding disk, or a device for reading data based on communication via a LAN or the like.

The calculate processing part 212 is comprised of a CPU, a memory, etc., in which in this embodiment, a program for image restoration is installed to perform operations as respective parts mentioned below on the basis of the program.

The captured image acquiring part 213 is a part for temporarily storing the already-captured image data inputted from the input part 211. It should be noted that the following description is given with reference to an example that only image data are stored in the captured image acquiring part 213 from the input part 211, but in another situation, information about an area (specific area) to be subjected to the PSF calculation among the image data may be inputted form the input part 211 in association with the image data. In this situation, an area detecting operation using the feature detecting part 214 described below does not take place, and a PSF calculation takes place for an area to be subjected to the PSF calculation, stored in association with the image data.

The feature detecting part 214 is a part for detecting an area fitting to a feature of a subject designated by the user from the already-captured image data inputted from the input part 211. Features of subjects used for detection of the feature detecting part 214 may include, for example, a face of a human, a face of an animal, a building, an automobile, a train, an airplane, a ship/boat, a flower, etc. The feature detecting part 214 detects, from an image, a subject fitting to a feature of a subject (e.g., a face of a human, a face of an animal, etc.) selected from a plurality of features of subjects beforehand registered in the feature detecting part 214 by the user's operation using the manipulating part 220, and identifies a position of the detected subject from within the already-captured image.

The PSF calculating part 215 calculates a PSF (Point spread Function) from the image data. The calculation of this PSF is the same as the embodiments in the foregoing. The PSF calculating part 215, according to information about a position of the subject (main subject) detected by the feature detecting part 214, performs a calculation of PSF using an image at the specified position of the main subject. In this way, an ideal PSF can be obtained.

The de-convolution part 216 is a part for completing an image restoration calculation for the image data using the PSF calculated by the PSF calculating part 215, in this embodiment by performing de-convolution to reduce image vibration included in the captured image.

The restored image acquiring part 217 is a part for temporarily storing the restored image obtained as a result of executing the de-convolution in the de-convolution executing part 216.

The data storing part 218 is a part for storing the restored image, and is supposed to record it in a medium such as a hard disk device, memory card or data recoding disk.

The manipulating part 220 has a pointing device such as a mouse or a touch panel, a keyboard device, etc. and is a part for performing various kinds of manipulating inputs to a main unit of the computer 210.

The display part 230 is a part for displaying various kinds of information and images for the image restoration apparatus.

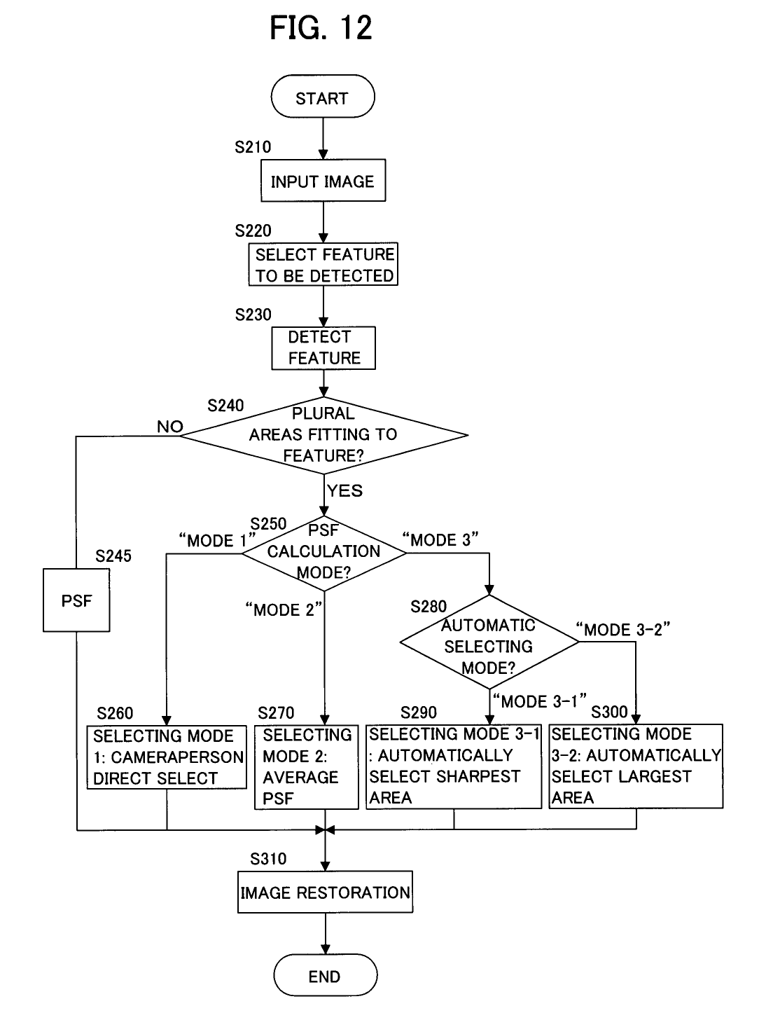

FIG. 12 is a flowchart for describing operations of the image restoration apparatus of the fifth embodiment.

Upon starting the operation of the image restoration apparatus, at first in a step (hereinafter, expressed just as “S”) 210, an already-captured image is inputted from e.g., a memory card or the like, and stored in the captured image acquiring part 213.

In S220, displaying is made in the display part 230 or other measures take place to prompt the user to input a feature of a subject. For example, icons corresponding to a face of a human, a face of an animal, a building, an automobile, a train, an airplane, a ship/boat, a flower, etc. are displayed so as to cause the user to select and input a feature of a subject by use of a mouse or the like of the manipulating part 220.

In S230, the feature detecting part 214 detects an area fitting to a feature of a subject designated in S220.

At this point, the feature detecting part 214 can detect plural areas in which a subject fitting to the selected feature of a subject exists. For example, when the selected feature of a subject is a face of a human, there may be plural persons within a subject field to be shot.

In S240, it is determined whether there are plural areas fitting to a feature of the subject detected from the image by the feature detecting part 214. If yes, the flows proceeds to S250, and if only one fitting area is detected, a PSF for such a single region is calculated (S245) and it proceeds to S310.

In S250, display is made such that the user is prompted to select a mode of calculating a PSF from within the plurality of areas detected, and the user is supposed to select and input it. This embodiment is intended to let the user select one from the following three modes.

### (Mode 1) This is a mode of displaying a plurality of areas being detected on the display part 230, and calculating a PSF for an area selected from them by the user via the manipulating part 220. If this mode is selected, the flow proceeds to S260.

(Mode 2) This is a mode of obtaining an average PSF for the plurally detected areas. If this mode is selected, the flow proceeds to S270.
(Mode 3) This is a mode of automatically selecting one area from the plurally detected areas, and a PSF calculation takes place for the selected area. If this mode is selected, the flow proceeds to S280.

In S260, a PSF is calculated according to Mode 1. That is, a PSF is calculated for an area selected by the user.

In S270, a PSF is calculated according to Mode 2. In this Mode 2, PSFs are calculated for the plurally detected areas, respectively to average them to further obtain an average PSF.

In S280, the user is made to select and input a sub-mode of automatically selecting an area to be subjected to a PSF calculation. Such an automatic selecting sub-mode may be any of the two following modes.

(Mode 3-1) This sub-mode is of selecting an area in which a sharp image can be obtained with the highest degree of definition. If this sub-mode is selected, the flow proceeds to S290.

### (Mode 3-2) This sub-mode is of selecting an area having the greatest ratio of an area occupied within the captured image”. If this sub-mode is selected, the flow proceeds to S300.

In S290, the PSF calculation takes place for an area in which a sharp image can be obtained with the highest degree of definition.

In S300, the PSF calculation takes place for an area having the greatest ratio of an area occupied within the captured image”.

In S310, de-convolution is carried out with a PSF obtained in any one of Modes 1, 2, 3-1 and 3-2 to obtain a restored image, and then completes this process.

As for which of the above-mentioned four modes should be used, the used one may be selected and inputted by the user preliminarily.

In this embodiment, since a main subject can be specified more exactly using a feature of a subject as described above, it is possible to acquire a favorable image meeting an intention of the user.

As an image restoration calculation such as blind de-convolution requires an enormous amount of operations, the computer 210 may be utilized so as to carry out such operations at a higher speed. The computer 210 may also utilized so as to conduct condition setting for image restoration calculation or something like that more precisely.

### (Modification)

The present invention is not limited to the embodiments described above, many kinds of modifications and variations can be realized, and these also come within the meaning and range of equivalency of the present invention.

(1) In the first embodiment, the description has been given in connection with an example that the AF area information acquiring part 13 compares a captured image with an image at the time of AF locking, which is provisionally saved at the time of AF locking, to specify at what position the subject covered by the AF area 21 at the time of AF locking is located within the captured image, but the invention is not limited to this example, or rather, for example, the AF area information acquiring part 13 may be arranged to recognize a subject in a position covered by the AF area at the time of AF locking, so as to successively update the position of the subject until the time of shooting to specify a position of a subject within the captured image. This arrangement may be implemented without many additional components by using image data used for a so-called through displayed image which continues to display an image obtained by the image pickup device on a display device provided on a rear face or the like of a camera before a shooting act.
(2) In the first and second embodiments, the description has been given in connection with an example that the PSF calculating part 14 and the de-convolution executing part 16 always perform PSF calculation and image restoring operation in the case of setting image restoration to be done, but the invention is not limited to this example, or rather, for example, it may be determined whether image vibration exists or not in the position of a main subject obtained by the AF area information acquiring part 13, and the image restoration may be performed only if the image vibration exists. In this case, it may be implemented that, for example, a function of judging presence or absence of image vibration is added to the AF area information acquiring part 13, and only if an instruction to carry out the image restoration is received from the AF area information acquiring part 13, the PSF calculating part 13 and the de-convolution executing part 16 perform their processing about the image restoration.
(3) Although in the embodiments it has been described by way of example that the specified position information of the main subject is used for the PSF calculation, the invention is not limited to this, and the position information may be used for other applications, e.g., of determining of an exposure value, correcting of exposure, changing of a gain (sensitivity), and so on.
(4) In the first embodiment and the second embodiment, it has been described by way of example that the data saving part 18 saves a captured image and a restored image, but in this case, the specified position information of the main subject may be added to the captured image, or the position information of the main subject and/or information about the calculated PSF, etc. may be added to the restored image.
(5) Although in the third embodiment it has been described by way of example that the image restoration is performed using the computer 100 in which a program is installed, the invention is not limited to this, and it may be performed using a device dedicated for the image restoration that is capable of operating in the same manner as the PSF calculating part 14, de-convolution executing part 16 and restored image acquiring part 17. Furthermore, such devices may be installed in service stores or business hub establishments, or somewhere of e.g. photo printing service dealers, and the photographer may pass the captured image data supplemented with information about the main subject position via a recoding medium or communication tool to the dealer, whereupon the dealer performs its image restoration processing and records the resultant restored image on a recording medium or prints it.
(6) Although in the third embodiment it has been described by way of example that information about a position of the main subject obtained in the same way as in the first embodiment is added to data of the captured image, the invention is not limited to this, and a position of a face may be determined as with the second embodiment to specify the position of the main subject and information of the position of this main subject may be added to the captured image data.
(7) Although in the third embodiment it has been described by way of example in which the camera 30 that does not have the PSF calculating part 14, de-convolution executing part 16 and restored image acquiring part 17 with which the camera 10 of the first embodiment is provided is used, the invention is not limited to this, and for example, it is possible to use a camera similar to the camera 10 of the first embodiment, the camera 20 of the second embodiment or the like and add information about a position of the main subject to data of the captured image.

### (8) A “specific area” is not limited to the AF area, a position of the main subject, a position of a face, and a position of an eye, which have been described, or rather, any area within a captured image may be used as a specific area.

(9) Although in the fourth embodiment it has been described by way of example that the image restoration further takes place for an image shot while performing vibration reduction operation using the optical vibration reducing part, the invention is not limited to this, and for example, use may be made of a camera that does not have the optical vibration reducing part.

It should be noted that the image restoration using the point spread function (PSF) in the embodiments may be used together with a gray-scale compression technique by which only brightness of excessively bright or dark portions within an image screen is boosted as described in a U.S. Ser. No. 11/224,926 filed on Sep. 14, 2005 in the U.S.A. by the same applicant as the present application and a U.S. Ser. No. 11/583,777 filed on Oct. 20, 2006 in the U.S.A. by the same applicant as the present application.

In this case, the image restoration using a point spread function in the embodiments may be performed after the gray-scale compression technique is implemented. Alternatively, the gray-scale compression technique may be implemented after the image restoration using a point spread function in the embodiments is performed.

Teachings of the U.S. Ser. No. 11/224,926 and Ser. No. 11/583,777 are incorporated herein as part of disclosure of the present application.

What is claimed is:

1. An image restoration apparatus comprising:
a specific part that specifies a specific area within a captured image; and
a calculating part that calculates a point spread function using an image in the specific area within the captured image, and performs an image restoration calculation for the captured image using the point spread function.

2. The image restoration apparatus according to claim 1, wherein
the calculating part calculates the point spread function through iterative computation.

3. The image restoration apparatus according to claim 1, wherein
the specific part specifies an area within the captured image in which a main subject exists, as the specific area.

4. A camera comprising:
a specific part that specifies a specific area within a captured image; and
a calculating part that calculates a point spread function using an image in the specific area within the captured image, and performs an image restoration calculation for the captured image using the point spread function.

5. The camera according to claim 4, wherein
the specific part sets an area corresponding to a focal point detecting area set within a capture field of view of the camera as the specific area.

6. The camera according to claim 4, wherein
the specific part specifies the specific area again in response to a change in the composition of the captured image.

7. The camera according to claim 4, wherein
the specific part specifies the area of the captured image in which the subject specified prior to the change in the composition exists, when the composition of the captured image is changed, and sets the specified area as the specific area.

8. The camera according to claim 4, wherein
the specific part compares the specific area specified prior to the change in composition and the captured image after the change in composition to specify the specific area again when the composition of the captured image is changed.

9. The camera according to claim 4, wherein
the specific part compares the image obtained prior to the change in composition and the captured image to specify the specific area, when composition of the captured image is changed; and
an image in the specific area specified prior to the change in composition is the image when imaging conditions of a lens are fixed, and also the image in an area corresponding to the focal point detecting area set within the capture field of view of the camera.

10. The camera according to claim 4, wherein
the specific part specifies a subject located in the focal point detecting area set within a capture field of view when imaging conditions of the lens are fixed, specifies the area of the subject within a capture field of view by tracking the subject, and sets the specified area as the specific area.

11. The camera according to claim 4, wherein
the specific part sets an area including a face of a subject as the specific area.

12. The camera according to claim 4, wherein
the specific part sets an area including an eye of a subject as the specific area.

13. The camera according to claim 4, comprising:
an input part that inputs a position within the captured image, and
the specific part sets an area within the captured image corresponding to the position inputted by the input part as the specific area.

14. The camera according to claim 4, wherein
the camera includes a control part that controls the calculating part, and
the calculating part carries out the image restoration calculation when a control signal is supplied from the control part.

15. The camera according to claim 4, wherein
the camera includes a control part that controls the calculating part,
the calculating part carries out the image restoration calculation when a control signal is supplied from the control part, and
the control part supplies the control signal to the calculating part when it is determined that the captured image includes image vibration.

16. A camera comprising:
a specific part that specifies a specific area within a captured image; and
an output part that outputs the captured image and information about the specific area specified by the specific part.

17. An image restoration apparatus comprising:
an input part to which a captured image and information about a specific area within the captured image are inputted; and
a calculating part that calculates a point spread function using an image in the specific area within the captured image, and carries out the image restoration calculation for the captured image using the point spread function.

18. The image restoration apparatus according to claim 17, wherein
the calculating part calculates the point spread function through iterative computation.

19. A program that makes a computer function as:
a specific part that specifies a specific area within a captured image; and
a calculating part that calculates a point spread function using an image in the specific area within the captured image, and performs an image restoration calculation for the captured image using the point spread function.

20. The program according to claim 19, wherein
the calculating part calculates the point spread function through iterative computation.

21. A camera comprising:
a specific part that specifies a specific area corresponding to a focal point detecting area set within a capture field of view; and
a correction part that corrects image vibration included in a captured image using the specific area.

22. A camera comprising:
a specific part that specifies a specific area including a face of a subject within a captured image; and
a correction part that corrects image vibration included in a captured image using the specific area.

23. A camera comprising:
a specific part that specifies a specific area corresponding to a focal point detecting area set within a capture field of view; and
an output part that outputs information about the specific area specified by the specific part along with a captured image.

24. An image restoration apparatus comprising:
an input part to which a captured image and information about a specific area corresponding to a focal point detecting area set within a capture field of view; and
a correction part that correcting image vibration included in the captured image using the specific area.

25. A camera comprising:
a specific part that specifies a specific area including a face of a subject within a captured image; and
an output part that outputs information about the specific area specified by the specific part along with a captured image.

26. An image restoration apparatus comprising:
an input part to which a captured image and information about a specific area including a face of a subject within the captured image are inputted; and
a correction part that corrects image vibration included in the captured image using the specific area.

27. The program according to claim 19, wherein
the specific part specifies the specific area based on a feature of a subject.

28. The program according to claim 19, wherein
the specific part specifies the specific area based on a feature of a subject, and
the program makes a computer function as a subject feature input part that inputs the feature of the subject.

29. The program according to claim 19, wherein
the specific part specifies the specific area based on a feature of a subject, and
the specific part uses at least a face of the subject as the feature of the subject.

30. The program according to claim 19, wherein
the specific part specifies the specific area based on a feature of a subject, and
the program makes a computer function as a specific area selecting part that selects one specific area when there are a plurality of specific areas specified based on the feature of the subject by the specific part.

31. The program according to claim 19, wherein
the specific part specifies the specific area based on a feature of a subject,
the program have a computer function as a specific area selecting part that selects one specific area when there are a plurality of specific areas specified based on the feature of the subject by the specific part, and
the specific area selecting part selects an area having the highest degree of definition of an image as a specific area.

32. The program according to claim 19, wherein
the specific part specifies the specific area based on a feature of a subject,
the program have a computer function as a specific area selecting part that selects one specific area when there are a plurality of specific areas specified based on the feature of the subject by the specific part, and
the specific area selecting part selects an area having the largest ration in a captured image as a specific area.

33. The image restoration apparatus according to claim 1, wherein
the specific part specifies the specific area based on a feature of a subject.

34. The image restoration apparatus according to claim 1, wherein
the specific part specifies the specific area based on a feature of a subject, and
a subject feature input part that inputs a feature of the subject is comprised.

35. The image restoration apparatus according to claim 1, wherein
the specific part specifies the specific area based on a feature of a subject, and
the specific part uses at least a face of a subject as the feature of the subject.

36. The image restoration apparatus according to claim 1, wherein
the specific part specifies the specific area based on a feature of a subject, and
a specific area selecting part that selects at least one of a plurality of the specific areas specified based on the feature of the subject by the specific part is comprised.

37. The image restoration apparatus according to claim 1, wherein
the specific part specifies the specific area based on a feature of a subject,
a specific area selecting part that selects one specific area when there are a plurality of specific areas specified based on the feature of the subject by the specific part is comprised, and
the specific area selecting part selects a specific area having the highest degree of definition of an image.

38. The image restoration apparatus according to claim 1, wherein
the specific part specifies the specific area based on a feature of a subject,
a specific area selecting part that selects one specific area when there are a plurality of specific areas specified based on the feature of the subject by the specific part is comprised, and
the specific area selecting part selects a specific area including the largest subject.

39. The camera according to claim 4, wherein
the specific part specifies the specific area based on a feature of a subject.

40. The camera according to claim 4, wherein
the specific part specifies the specific area based on a feature of a subject, and
a subject feature input part that inputs the feature of the subject is comprised.

41. The camera according to claim 4, wherein
the specific part specifies the specific area based on a feature of a subject, and
the specific part uses at least a face of a subject as the feature of the subject.

42. The camera according to claim 4, wherein
the specific part specifies the specific area based on a feature of a subject, and
a specific area selecting part that selects one specific area when there are a plurality of specific areas specified based on the feature of the subject by the specific part is comprised.

43. The camera according to claim 4, wherein
the specific part specifies the specific area based on a feature of a subject,
a specific area selecting part that selects one specific area when there are a plurality of specific areas specified based on the feature of the subject by the specific part is comprised, and
the specific area selecting part selects an area having the highest degree of definition of an image as a specific area.

44. The camera according to claim 4, wherein
the specific part specifies the specific area based on a feature of a subject,
a specific area selecting part that selects one specific area when there are a plurality of specific areas specified based on the feature of the subject by the specific part is comprised, and
the specific area selecting part selects an area having the largest ratio in the captured image as a specific area.

45. The camera according to claim 4, wherein
the calculating part interrupts or aborts the image restoration calculation when a higher priority command is made active during the execution of the image restoration calculation.

46. The camera according to claim 4, wherein
the calculating part interrupts or aborts the image restoration calculation when a higher priority command is made active during the execution of the image restoration calculation, and
the higher priority command includes any operation selected from the group of operations consisting of: operation of a release button, operation of a menu button, operation of a command selecting dial, and operation of a power supply button.

47. The camera according to claim 4, wherein
the calculating part interrupts or aborts the image restoration calculation when a higher priority operation is made active during the execution of the image restoration calculation, and
the calculating part resumes the restoration calculation after completion of operations based on the higher priority command.

48. The camera according to claim 4, wherein
an optical vibration reducing part that reduces image vibration of a captured image by moving at least part of an optical shooting member during shooting action,
the calculating part is capable of performing the image restoration calculation for the captured image obtained by use of the optical vibration reducing part.
